(19) United States
(12) Patent Application Publication
(10) Pub. No.: US 2009/0092329 A1
(43) Pub. Date: Apr. 9, 2009

(54) Image processing apparatus and image display system

(75) Inventors: Tsung-Hsiang Huang, Changhua County (TW); Chun-Ming Cheng, Taipei County (TW)

Correspondence Address: Joe McKinney Muncy, PO Box 1364, Fairfax, VA, 22038-1364, US

(73) Assignee: PRINCETON TECHNOLOGY CORPORATION

(21) Appl. No.: 12/010,299

(22) Filed: Jan. 23, 2008

(30) Foreign Application Priority Data
Oct. 5, 2007 (TW) 096216654

(51) Int. Cl. G06K 9/36

(52) U.S. Cl. 382/238

(57) ABSTRACT

An image processing apparatus is provided. The image processing apparatus comprises a storage module, a processing module and an output module. The storage module is used for storing an image file. The processing module is coupled to the storage module for performing a coordinate conversion on the image file based on a predetermined manner to generate a converted file, and storing the converted file in the storage module. The output module is coupled to the storage module for reading the converted file from the storage module and processing it to output an image signal.

### BACKGROUND OF THE INVENTION

1. Field of the Invention

The invention relates to an image processing apparatus, and in particular, to an image processing apparatus adapted in a field emission display (FED).

2. Description of the Related Art

Conventionally, a display is horizontally deposited, and the status is referred to as a horizontal mode featuring a longer horizontal edge and a shorter vertical edge. Some images such as a portrait may be cropped by a horizontally deposited display because its height exceeds the vertical boundary while the width is zoomed to fit the horizontal boundary. Nevertheless, the total portrait can be properly fit in a vertically deposited display without undesirable crops. A vertically deposited display, is gaining usage as it is particularly adaptable for portrait images.

FIG. 1 shows an image scanning process for a display in horizontal mode, and FIG. 2 shows an image scanning process for a display in vertical mode. When the display is rotated from horizontal mode to vertical mode, the displayed image in FIG. 1 is also rotated as shown in FIG. 2. To hold orientation of the displayed image, a conversion is required to convert coordinates of pixels in the image file. Thereby, the displayed image remains un-rotated while the display is rotated.

Before an image signal is displayed on an image display system, an image file stored in a Synchronous Dynamic Random Access Memory (SDRAM) device is first processed by an image processing apparatus to generate a processed image file which is stored in the same SDRAM device. The sequence of image processing is shown as FIG. 1, wherein the arrows sequentially process the image file line by line. Until all lines are processed, the processed image file stored in the SDRAM device, until it is completely converted to the image signal for display.

When the image display system operates in vertical mode, the image processing apparatus may encounter difficulties while displaying the image signal. In a typical SDRAM device, data access for one same row is very efficient. Conversely, when consecutive rows are vertically accessed, the performance may significantly degrade. When the display is vertically deposited, the image processing apparatus must issue consecutive vertical data accesses to the SDRAM device. In this case, longer time is required to process the image file due to its physical inefficiency, and the display effect is deemed unsatisfactory as requirements for quality and performance are getting challenging nowadays. Therefore, it is desirable to propose an enhanced approach so that the processing time can be reduced while efficiency is increased.

### BRIEF SUMMARY OF THE INVENTION

The invention proposes an image processing apparatus and an image display system capable of reducing image processing time.

An exemplary embodiment of an image processing apparatus is provided, comprising a storage module, a processing module and an output module. The storage module stores an image file. The processing module performs a coordinate conversion on the image file based on a predetermined manner to generate a converted file, and stores the converted file in the storage module. The output module reads the converted file from the storage module and processes it to output an image signal.

Another embodiment is an image display system is also provided. The image display system comprises a conversion module, a storage module, a processing module, an output module and a display module. The conversion module converts a frame image into an image file. The storage module stores the image file. The processing module performs a coordinate conversion on the image file based on a predetermined manner to generate a converted file, and stores the converted file in the storage module. The output module reads the converted file from the storage module and processes it to output an image signal. The display module displays the image signal.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an image scanning procedure for a display in horizontal mode;

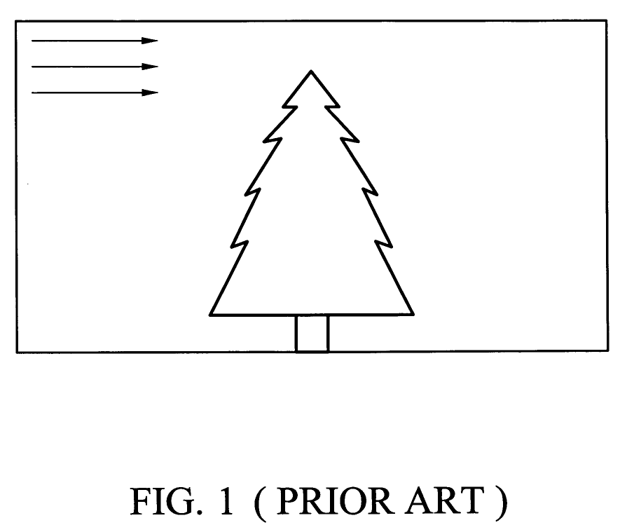

FIG. 2 shows an image scanning procedure for a display in vertical mode;

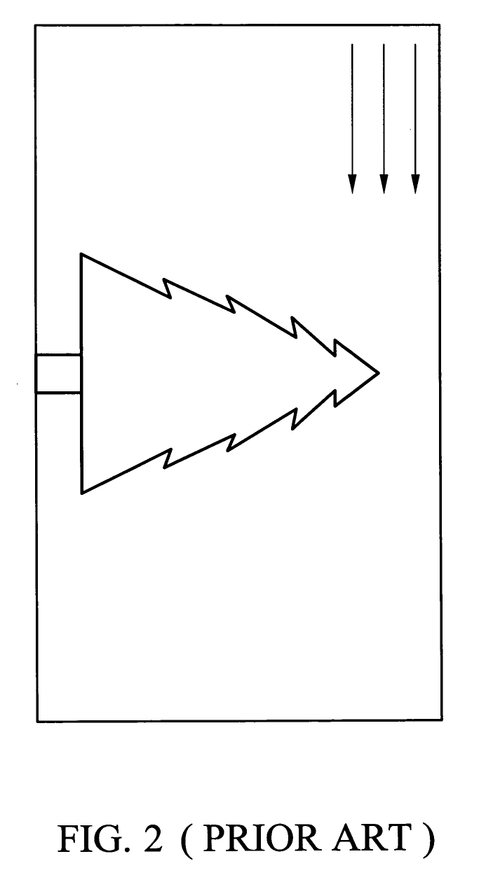

FIG. 3 shows an embodiment of an image processing apparatus according to the invention;

FIG. 4 shows an embodiment of a coordinate conversion according to the invention; and

FIG. 5 shows an embodiment of an image display system according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

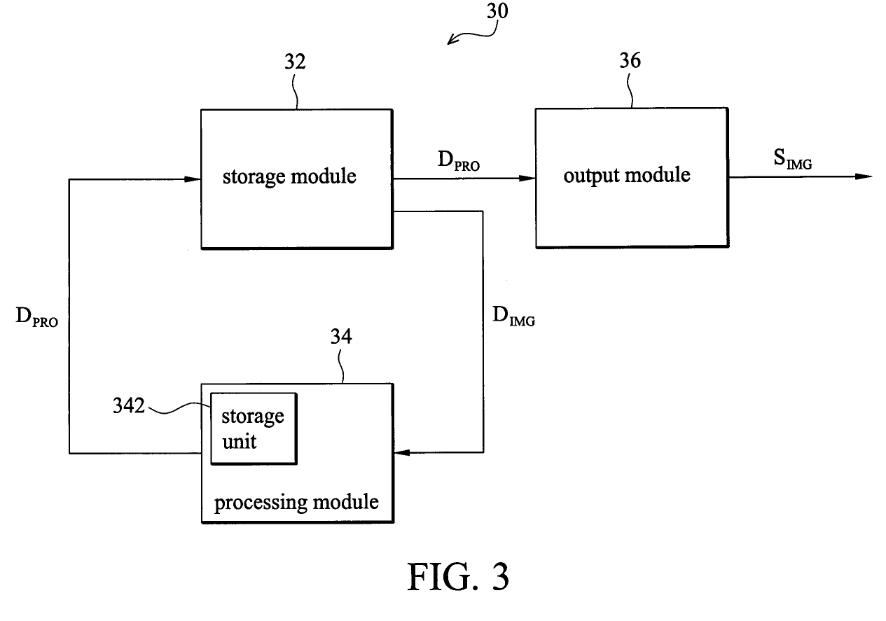

FIG. 3 shows an embodiment of an image processing apparatus according to the invention. The image processing apparatus 30 comprises a storage module 32, a processing module processing module 34 and an output module 36. The storage module 32 stores an image file D_{IMG}. The processing module 34 is coupled to the storage module 32, performing a coordinate conversion on the image file D_{IMG} based on a predetermined manner to generate a converted file D_{PRO}. The converted file D_{PRO} is also stored in the storage module 32. The output module 36 is coupled to the storage module 32, for reading the converted file D_{PRO} stored in the storage module 32, and processing it to output an image signal S_{IMG}.

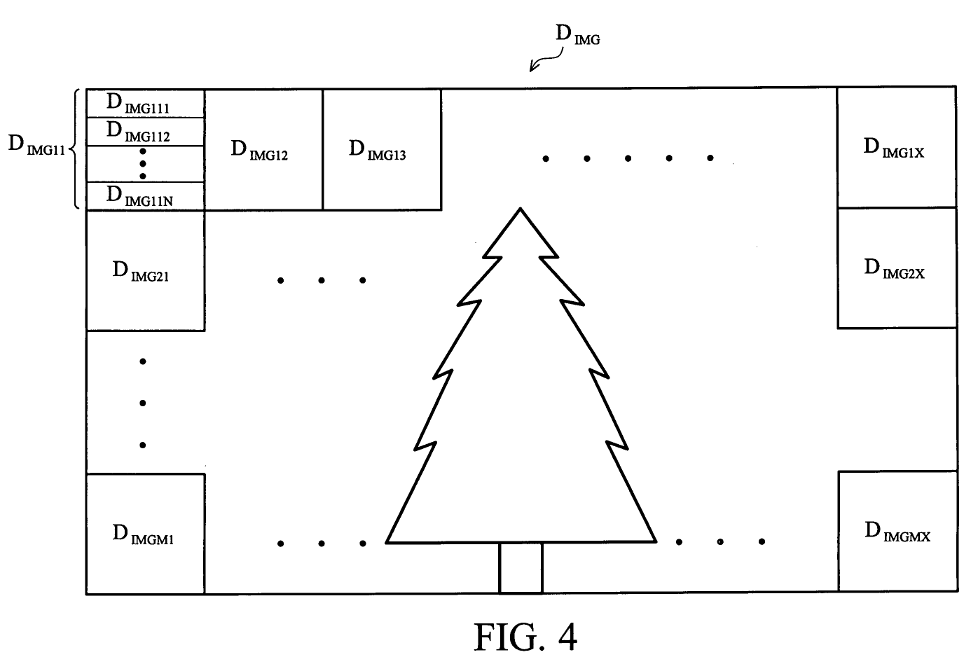

FIG. 4 shows an embodiment of a coordinate conversion according to the invention. As shown in FIG. 4, the processing module 34 divides the image file D_{IMG} into a plurality of subsets D_{IMG11}˜D_{IMGMX}. As an example, the processing module processing module 34 divides the image file D_{IMG} into M*X subsets, where M is the number of subsets, and X is the number of sub-subsets in each of the M subsets. The first subset comprises subsets D_{IMG11} to D_{IMG1X}, the second subset comprises D_{IMG21} to D_{IMG2X}, and analogically, the M^{th} subset comprises D_{IMGM1} to D_{IMGMX}. In one embodiment, the processing module 34 further comprises a storage unit 342. The subsets D_{IMG11} to D_{IMGMX} are sequentially stored in the storage unit 342 after division from the image file D_{IMG}. The processing module 34 then sequentially performs the coordinate conversion on the subsets D_{IMG11} to D_{IMGMX} stored in the storage unit 342 to generate the converted file D_{PRO}. Specifically, the first subset D_{IMG11} is first read, converted and stored, and the following subset D_{IMG12} is likewise processed. In this way, the processing module 34 generates the converted file D_{PRO} until all the subsets D_{IMG11} to D_{IMGMX} are recursively processed. Each of the subsets comprises N columns, and the predetermined manner is a range from the first columns of subsets D_{IMG11} to D_{IMG1X} to the N^{th} columns of subsets D_{IMGM1} to D_{IMGMX}.

As an example in FIG. 4, the first subset D_{IMG11} of the image file D_{IMG} comprises N columns D_{IMG111} to D_{IMG11N}. The processing module 34 sequentially performs the coordinate conversion on the columns D_{IMG111}, D_{IMG112} and so on, and until the N^{th} column D_{IMG11N} is converted, the next subset D_{IMG12} is processed. When coordinates of all the subsets D_{IMG11} to D_{IMG1X} are converted, conversions for the next subsets D_{IMG21} to D_{IMG2X} are consecutively initiated. According to the described sequence, the image file D_{IMG} is converted to the converted file D_{PRO} whereby coordinates of pixels in the subsets D_{IMG11} to D_{IMGMX} are converted. The converted file D_{PRO} is then stored in the storage module 32.

In one embodiment, the storage module 32 is an SDRAM device, and the storage unit 342 may be a Static Random Access Memory (SRAM) device.

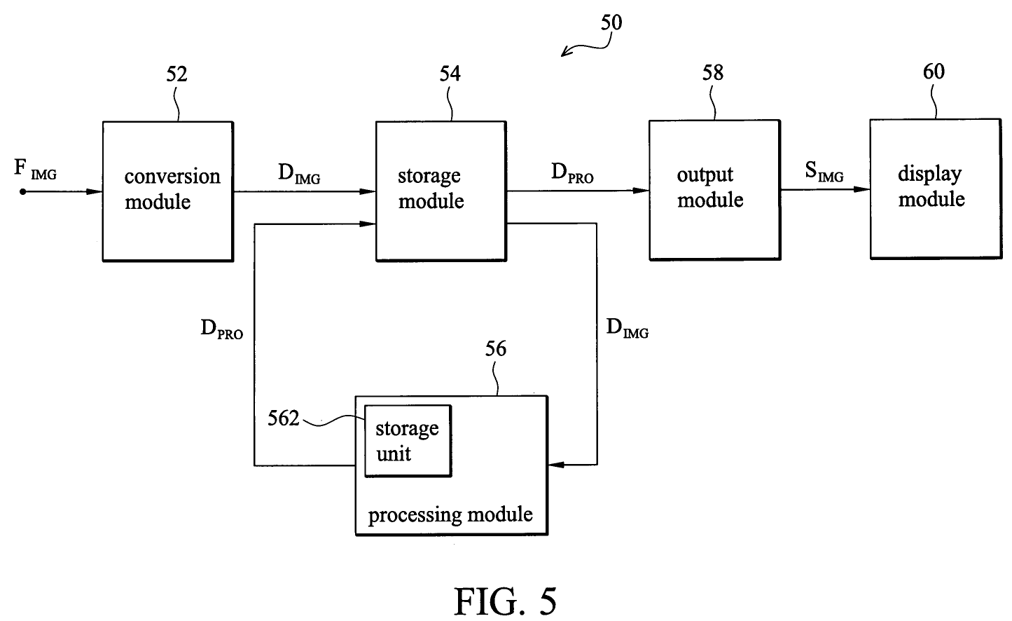

FIG. 5 shows an embodiment of an image display system according to the invention. The image display system 50 comprises a conversion module 52, a storage module 54, a processing module 56, an output module 58 and a display module 60. The conversion module 52 is employed to convert a frame image F_{IMG} into an image file D_{IMG}, and specifically, the frame image F_{IMG} is progressively scanned by the conversion module 52 while generating the image file D_{IMG}. The storage module 54 is coupled to the conversion module 52 for storage of the image file D_{IMG}, and as described, the storage module 54 may be a SDRAM device. The processing module 56 is coupled to the storage module 54, performing a coordinate conversion on the image file D_{IMG} based on a predetermined manner to generate a converted file D_{PRO}. The converted file D_{PRO} is also stored in the storage module 54. The output module 58 is coupled to the storage module 54 for reading the converted file D_{PRO} and converting it to an image signal S_{IMG}. The display module 60 is coupled to the output module 58, receiving the image signal S_{IMG} for display. In one embodiment, the display module 60 may be a field emission display (FED).

The processing module 56 may divide the image file D_{IMG} into a plurality of subsets, and perform the coordinate conversion sequentially on each of the subsets. Each of the subsets may comprise N columns, and the predetermined manner is a range from the first column to the N^{th} column of the subsets. The number and sizes of the subsets may be variable dependent on applications, whereby the performance of the storage module can be optimized for difference circumstances.

Additionally, the processing module 56 may further comprise a storage unit 562 for buffering a plurality of subsets read from the storage module 54, and the coordinate conversion is performed on the buffered subsets based on the predetermined manner. The storage unit 562 may be an SRAM device.

In the embodiments disclosed, performances of the image processing apparatus and image display system are increased by optimizing accesses to the storage module. Coordinates of the image file is converted by dividing into the image file a plurality of subsets and sequentially processing the conversion on each subset. Efficiency is thereby increased while time consumption is reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image processing apparatus, comprising:
a storage module, for storing an image file;
a processing module, coupled to the storage module, performing a coordinate conversion on the image file based on a predetermined manner to generate a converted file, and storing the converted file in the storage module; and
an output module, coupled to the storage module, reading the converted file from the storage module and processing it to output an image signal.

2. The image processing apparatus as claimed in claim 1, wherein the processing module divides the image file into a plurality of subsets, and individually converts coordinates of the subsets based on the predetermined manner.

3. The image processing apparatus as claimed in claim 2, wherein the processing module comprises a storage unit, buffering one or more subsets sequentially read from the storage module, whereby the processing module performs the coordinate conversion on the buffered subsets.

4. The image processing apparatus as claimed in claim 3, wherein each of the subsets comprises N column pixels, and the image processing module performs the coordinate conversion based on the predetermined manner to sequentially convert coordinates of pixels from a first column to an N^{th} column in each subset.

5. The image processing apparatus as claimed in claim 5, wherein the storage unit is a Static Random Access Memory (SRAM) device.

6. The image processing apparatus as claimed in claim 1, wherein the storage module is a Synchronous Dynamic Random Access Memory (SDRAM) device.

7. An image display system, comprising:
a conversion module, for converting a frame image into an image file;
a storage module, coupled to the conversion module for storage of the image file;
a processing module, coupled to the storage module, performing a coordinate conversion on the image file based on a predetermined manner to generate a converted file, and storing the converted file in the storage module;
an output module, coupled to the storage module, reading the converted file from the storage module and processing it to output an image signal; and
a display module, coupled to the output module for displaying the image signal.

8. The image display system as claimed in claim 7, wherein the conversion module progressively scans the frame image to generate the image file.

9. The image display system as claimed in claim 7, wherein the processing module divides the image file into a plurality of subsets, and individually converts coordinates of the subsets based on the predetermined manner.

10. The image display system as claimed in claim 9, wherein the processing module comprises a storage unit, buffering one or more subsets sequentially read from the storage module, whereby the processing module performs the coordinate conversion on the buffered subsets.

11. The image display system as claimed in claim 10, wherein each of the subsets comprises N column pixels, and the image processing module performs the coordinate conversion based on the predetermined manner to sequentially convert coordinates of pixels from the first column to the N^{th} column in each subset.

12. The image display system as claimed in claim 11, wherein the storage unit is a Static Random Access Memory (SRAM) device.

13. The image display system as claimed in claim 7, wherein the storage module is a Synchronous Dynamic Random Access Memory (SDRAM) device.

14. The image display system as claimed in claim 7, wherein the display module is a field emission display (FED).
